(19) United States
(12) Patent Application Publication
(10) Pub. No.: US 2007/0245111 A1
(43) Pub. Date: Oct. 18, 2007

(54) METHODS, SYSTEMS, AND COMPUTER PROGRAM PRODUCTS FOR MANAGING TEMPORARY STORAGE

(75) Inventors: Thomas M. McBride, Mantorville, MN (US); Robert A. Petrillo, Lanesboro, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: International Business Machines Corporation, Armonk, NY (US)

(21) Appl. No.: 11/379,073

(22) Filed: Apr. 18, 2006

(51) Int. Cl. G06F 12/00

(52) U.S. Cl. 711/170

(57) ABSTRACT

A method, system, and computer program product for managing storage is provided. The method includes requesting registration from an application upon initialization of the application, receiving the registration from the application, and receiving a request for temporary storage from the application. The method also includes determining whether sufficient memory exists in storage to perform the request. If insufficient memory exists, the method includes signaling the application to halt operations that request additional temporary storage, signaling the application to return unused temporary storage, and re-attempting to execute the request upon successful return of unused temporary storage. If sufficient memory exists, the method includes executing the request.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to storage management, and particularly to facilitating storage reclamation of unused temporary storage.

2. Description of Background

Large applications that run on today's computer systems require an increasing amount of temporary storage. Typically the operating system attempts to manage the distribution of the temporary storage within its storage management component but the returning of unused temporary storage is under the control of the application which uses the temporary storage. As applications become larger, support more users, and manipulate larger data objects, they require more temporary storage and often try to manage this storage with internal application storage managers. The returning of unused storage by these application storage managers is secondary to the distribution of storage to the application and its various components. This typically done for performance reasons to obtain the highest throughput by the application. One example of this type of application is the Java Virtual Machine® whose garbage collector executes when there is a low enough paging rate and typically executes at a low priority. However, this is true of any application which attempts to manage its own storage independent of the operation system storage manager.

Because an application storage manager may not obtain enough execution cycles to return all of the unused storage it is holding because of a heavy workload on the machine, the operating system storage manager may run out of temporary storage even though there may be a significant amount of storage ready to be returned by the various application storage managers. In the typical operating system storage manager, this will result in the termination of the machine.

Although there have been attempts to minimize the effects of application storage managers on overall system storage by executing the applications from within their own storage pool, this approach has its drawbacks. Some application storage managers have attempted to detect when the operating system storage manager is timing out of storage and return unused storage on a higher priority basis, but this falls short when large numbers of applications are executing each with different storage handling philosophies.

What is needed, therefore, is a means for an operating system storage manger to elicit assistance from the various application storage managers when storage consumption is becoming critical in order to force the return of unused temporary storage.

### SUMMARY OF THE INVENTION

The shortcomings of the prior art are overcome and additional advantages are provided through the provision of a method for managing temporary storage. The method includes requesting registration from an application upon initialization of the application, receiving the registration from the application, and receiving a request for temporary storage from the application. The method also includes determining whether sufficient memory exists in storage to perform the request. If insufficient memory exists, the method includes signaling the application to halt operations that request additional temporary storage, signaling the application to return unused temporary storage, and re-attempting to execute the request upon successful return of unused temporary storage. If sufficient memory exists, the method includes executing the request.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which minimizes the risk of abnormal system terminations due to insufficient memory in temporary storage by enabling an operating system storage manager to force various application storage managers to return unused temporary storage when the system temporary storage falls below a threshold.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system upon which the storage management interface may be implemented in exemplary embodiments; and

FIG. 2 illustrates one example of a flow diagram describing a process for implementing storage reclamation and management of temporary storage.

The detailed description explains the preferred embodiments of the invention, together with advantages and features, by way of example with reference to the drawings.

### DETAILED DESCRIPTION OF THE INVENTION

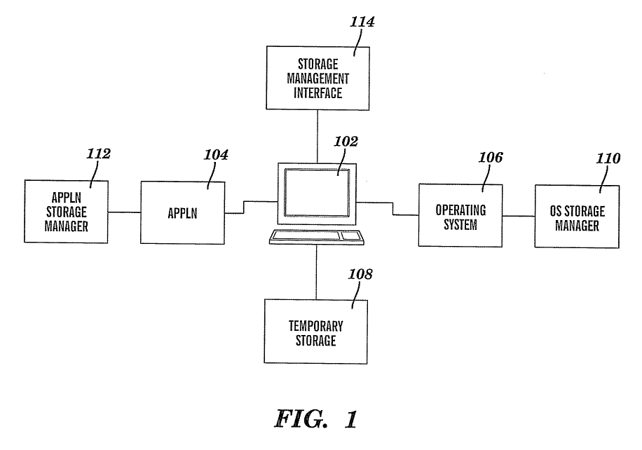

Turning now to the drawings in greater detail, it will be seen that in FIG. 1 there is block diagram upon which the storage management system may be implemented in exemplary embodiments. The system of FIG. 1 includes a computer processing device 102 that executes one or more applications (e.g., application 104) and an operating system 106. Computer processing device 102 may be a general-purpose computer, a mid-to-large computer system (e.g., mainframe), or may be as small as a personal digital assistant. The computer processing device 102 includes memory, which may be an internal hard disk drive or auxiliary storage device. The memory includes temporary storage 108 that is reserved for particular application operations as is generally known in the art.

The applications, e.g., application 104 include an application storage manager 112 that manages the return of unused temporary storage it has requested from the operating system. Each application executing on computer processing device 102 may include its own application storage manager for this purpose. Applications may include business or personal applications (e.g., word processing program), web-based applications, etc.

Operating system 106 includes an operating system storage manager 110 that manages the distribution of temporary storage to requesting applications.

Also included in the system of FIG. 1 is a storage management interface 114 that implements the temporary storage management activities described herein. While shown as a separate application in the system of FIG. 1 for illustrative purposes, in exemplary embodiments, the storage management interface 114 is a component of the operating system storage manager 110. It will be understood that various other configurations may be realized in order to achieve the advantages of the invention. For example, the storage management interface 114 may be an application programming interface with respect to the operating system 106.

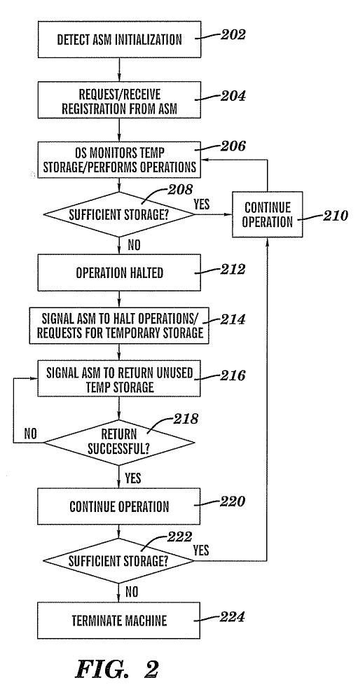

As indicated above, the storage management system allows an operating system storage manager to force application storage managers to return unused temporary storage they are holding when the system temporary storage falls below a threshold, typically when storage is critically low. The storage management interface 114 communicates with application storage managers (or with the applications if no storage manager exists) on behalf of the operating system storage manager 110 as described herein. Turning now to FIG. 2, a flow diagram describing a process for implementing the storage management system activities will now be described in exemplary embodiments.

At step 202, the storage manager interface 114 detects initialization of application storage manager 112. Upon detection, the storage management interface 114 requests registration from the application storage manager 112 at step 204. This may be accomplished by a command signal transmitted to the application. Step 204 includes receiving the registration from the application storage manager 112. In alternative embodiments, the application storage manager may register itself by signaling the storage manager interface during its initialization.

At step 206, the temporary storage 108 is monitored as various operations are performed in response to requests from application 104 including requests for temporary storage. At step 208, it is determined whether sufficient memory exists in temporary storage to complete the requested operation (e.g., a request for an amount of temporary storage). If so, the request is executed by the operating system at step 210 and the process returns to step 206.

If, however, insufficient memory exists the requested operation is halted at step 212 and a signal is transmitted to the application storage manager 112 to halt current operations that request temporary storage, as well as future requests for temporary storage at step 214. The storage management interface 114 signals the application storage manager 112 to return unused temporary storage at step 216. The signal transmitted in step 216 may cause the storage management interface 114 to wait a specified time period for a response from the application storage manager 112.

At step 218, it is determined whether a response from the application storage manager 112 has been received indicating the return of unused temporary storage. If the response indicates that the return of temporary storage was unsuccessful, the process returns to step 216 whereby the request to return is repeated. This may continue a specified number of times if desired by configuring the storage management interface 114 to attempt this request a specified number of times.

If the response indicates that the return of unused temporary storage was successful, then the operating system 106 attempts to execute the request for temporary storage from step 206 at step 220. If sufficient memory exists to perform the request at step 222, the operation is executed at step 210. Otherwise, the operating system 106 issues an abnormal termination command at step 224 and the process ends.

The storage management interface may be utilized in any type of processing device that manages temporary storage for multiple applications. As indicated above, the storage management system minimizes the risk of abnormal system terminations due to insufficient memory in temporary storage by forcing various application storage managers to return unused temporary storage when the system temporary storage falls below a threshold.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for managing storage, comprising:
requesting registration from an application upon initialization of the application;
receiving the registration from the application;
receiving a request for temporary storage from the application;
determining whether sufficient memory exists in storage to perform the request;
if insufficient memory exists:
signaling the application to halt operations that request additional temporary storage;
signaling the application to return unused temporary storage; and
re-attempting to execute the request upon successful return of unused temporary storage; and
if sufficient memory exists, executing the request.

2. The method of claim 1, wherein registration includes signifying that the application is a component capable of holding unused temporary storage and is instructed to return unused temporary storage upon request.

3. The method of claim 1, further comprising:
terminating operations when, in response to the re-attempting, it is determined that insufficient memory remains in the storage.

4. A system for managing storage, comprising:
a computer processing device executing an application and an operating system that includes an operating system storage manager, the computer processing device including storage;
a storage management interface executing on the computer processing device, the storage management interface performing:
requesting registration from the application upon initialization of the application;
receiving the registration from the application;
receiving a request for temporary storage from the application;
determining whether sufficient memory exists in the storage to perform the request;
if insufficient memory exists:
signaling the application to halt operations that request additional temporary storage;
signaling the application to return unused temporary storage; and
re-attempting to execute the request upon successful return of unused temporary storage; and
if sufficient memory exists, executing the request.

5. The system of claim 4, wherein registration includes signifying that the application is a component capable of holding unused temporary storage and is instructed to return unused temporary storage upon request.

6. The system of claim 4, wherein the storage management interface further performs:
terminating operations when, in response to the re-attempting, it is determined that insufficient memory remains in the storage.

7. A computer program product for managing storage, the computer program product including instructions for implementing a method, comprising:
requesting registration from an application upon initialization of the application;
receiving the registration from the application;
receiving a request for temporary storage from the application;
determining whether sufficient memory exists in storage to perform the request;
if insufficient memory exists:
signaling the application to halt operations that request additional temporary storage;
signaling the application to return unused temporary storage; and
re-attempting to execute the request upon successful return of unused temporary storage; and
if sufficient memory exists, executing the request.

8. The computer program product of claim 7, wherein registration includes signifying that the application is a component capable of holding unused temporary storage and is instructed to return unused temporary storage upon request.

9. The computer program product of claim 7, further comprising instructions for performing:
terminating operations when, in response to the re-attempting, it is determined that insufficient memory remains in the storage.
